(19) United States
(12) Patent Application Publication
(10) Pub. No.: US 2026/0196709 A1
(43) Pub. Date: Jul. 9, 2026

(54) Label antenna structure suitable for the curved surfaces of liquid containers

(71) Applicant: Securitag Assembly Group Co., Ltd., TAICHUNG CITY (TW)

(72) Inventor: Kai-Jun LIANG, TAICHUNG CITY (TW)

(73) Assignee: Securitag Assembly Group Co., Ltd., TAICHUNG CITY (TW)

(21) Appl. No.: 19/188,819

(22) Filed: Apr. 24, 2025

(30) Foreign Application Priority Data
Jan. 3, 2025 (TW) 114100236

(51) Int. Cl. H01Q 1/22; H01Q 7/00

(52) U.S. Cl. CPC H01Q 1/2208; H01Q 7/00

(57) ABSTRACT

A label antenna structure suitable for the curved surfaces of liquid containers, comprising a deformed loop surrounding a first slit. The deformed loop includes a loop gap, a first electrical connection terminal, and a second electrical connection terminal, with the first electrical connection terminal and the second electrical connection terminal being separated by the loop gap. The structure also includes a single-arm radiating plate, with one end of the arm of the single-arm radiating plate being connected to the deformed loop; a second slit, which separates the unconnected portion between the deformed loop and the single-arm radiating plate, with one end of the second slit having an open circuit structure; and an RFID chip electrically connected between the first electrical connection terminal and the second electrical connection terminal.

### CROSS-REFERENCE TO RELATED APPLICATIONS

This non-provisional application claims priority under 35 U.S.C. § 119 on Patent Application No. TW 114100236 filed in Taiwan, Republic of China Jan. 3, 2025, the entire contents of which are hereby incorporated by reference in its entirety.

### FIELD OF THE INVENTION

A small-sized label antenna that can be attached to the curved surface of a liquid-containing medicine bottle, specifically a label antenna structure suitable for the curved surfaces of liquid containers.

### BACKGROUND OF INVENTION

Generally, ultra-high frequency RFID tag antennas are designed using symmetric far-field dipole antennas. In certain applications, such as in the presence of metals or liquid media, ultra-high frequency antennas may not effectively radiate electromagnetic waves, resulting in poor read range and affecting the performance of the tag antenna. The main reason for this is that when the antenna structure is near a liquid medium, an opposing current is induced inside the symmetric dipole antenna. The direction of the induced current is opposite to that of the original current, causing current cancellation, which prevents the antenna from radiating effectively.

For curved glass medicine bottles filled with liquid, the common solutions in the industry are as follows: (1) The antenna is suspended like a flag, as shown in the upper part of FIG. 9. This method of flag tag antenna 91 cannot be fully attached to the bottle, leading to many operational inconveniences. (2) As shown in the lower part of FIG. 9, the invention in patent TW 1686992B titled “Antenna Structure and Device Using the Antenna Structure” provides resistance to liquids. However, the flat tag antenna 92 cannot be applied to curved surfaces and is too large to be attached to bottles.

### SUMMARY OF THE INVENTION

In view of the above, the main feature of the present invention, a label antenna structure suitable for the curved surfaces of liquid containers, lies in its antenna design, which is composed of a deformed loop and an antenna radiant surface. The antenna radiant surface and the deformed loop are separated by an L-shaped slit and a rectangular slit, avoiding the use of winding wire segments that cause coupling effects between the circuits, which would lead to current cancellation and prevent effective radiant of energy. The antenna design uses a large metal radiant surface, with the deformed loop connected to the antenna radiant surface. The frequency is adjusted by varying the length of the antenna radiant surface (quarter wavelength) to achieve liquid-resistant read range performance.

The energy provided by the reader and the reading antenna is stored in the tag antenna. When sufficient activation energy is reached, the information is transmitted back to the reader using scattered signals, completing one reading cycle.

Based on the structure mentioned above, measurement tests were conducted on 20 bottles arranged on a tray, as shown in the table below. A single bottle at a specific position was measured using the electronic tag measurement system (Voyantic Tagformance) for the U.S. frequency band (902-928 MHz) to determine the label's minimum activation power (Power On Tag Forward). If the electronic tag measurement system detects the minimum activation power of a label on a liquid container's curved surface label antenna structure at 0 dBm or below, it is considered passed.

| | | | |
|---|---|---|---|
| D1 | C1 | B1 | A1 |
| D2 | C2 | B2 | A2 |
| D3 | C3 | B3 | A3 |
| D4 | C4 | B4 | A4 |
| D5 | C5 | B5 | A5 |

Two types of liquids (distilled water and sodium chloride) were tested, with 20 bottles of each distributed across various positions on the tray. In the U.S. frequency band, the Power On Tag Forward for both liquids was below 0 dBm, and both passed the test. The measurement results are shown in FIG. 10. The top-left image shows the frequency and minimum activation power measurement chart 93 for the distilled water glass bottle at position C3, while the top-right image shows the frequency and minimum activation power measurement chart 94 for the sodium chloride glass bottle at position C3.

In another scenario, in the U.S. frequency band 902-928 MHz, the read range was consistently over 4.5 meters. The read range in a multi-bottle environment was better than that in a single-bottle environment, demonstrating that the antenna is not affected by the liquid environment or the type of liquid. The measurement results are shown in FIG. 10. The bottom-left image shows the frequency and read range measurement chart 95 for the sodium chloride glass bottle placed at position C3, while the top-right image shows the frequency and read range measurement chart 96 for the sodium chloride glass bottles placed at all positions, with measurements taken at position C3.

A label antenna structure suitable for the curved surfaces of liquid containers, comprising a deformed loop surrounding a first slit. The deformed loop includes a loop gap, a first electrical connection terminal, and a second electrical connection terminal, with the first electrical connection terminal and the second electrical connection terminal being separated by the loop gap. The structure also includes a single-arm radiating plate, with one end of the arm of the single-arm radiating plate being connected to the deformed loop; a second slit, which separates the unconnected portion between the deformed loop and the single-arm radiating plate, with one end of the second slit having an open circuit structure; and an RFID chip electrically connected between the first electrical connection terminal and the second electrical connection terminal.

The advantages of the present invention over the prior art are: (1) The antenna's read distance performance is not affected when attached to flat or curved surfaces of liquid containers. (2) The read distance in multi-bottle liquid interference environments is better than in single-bottle liquid environments. (3) The antenna is adhered to all non-metallic liquid containers using the flexible substrate.

### BRIEF DESCRIPTION OF THE DRAWINGS

FIG. 1 Schematic diagram of a label antenna structure suitable for the curved surfaces of liquid containers.

FIG. 2 Schematic diagram of the components of a label antenna structure suitable for the curved surfaces of liquid containers.

FIG. 3 Schematic diagram of a label antenna structure suitable for the curved surfaces of liquid containers, including a third slot gap.

FIG. 4 Multiple radiating plates of a label antenna structure suitable for the curved surfaces of liquid containers.

FIG. 5 Quarter wavelength single-arm radiating plate and bent type winding.

FIG. 6 Unrestricted shape of the second and third slit.

FIG. 7 RFID chip installed in three segments of a deformed loop.

FIG. 8 Slit dimensions of a label antenna structure suitable for the curved surfaces of liquid containers.

FIG. 9 Flag label antenna and flat label antenna.

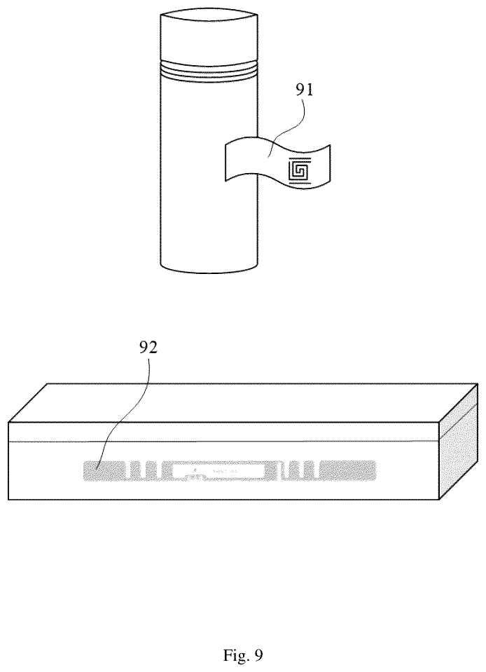

FIG. 10 Measurement diagram of distilled water and sodium chloride in bottled containers.

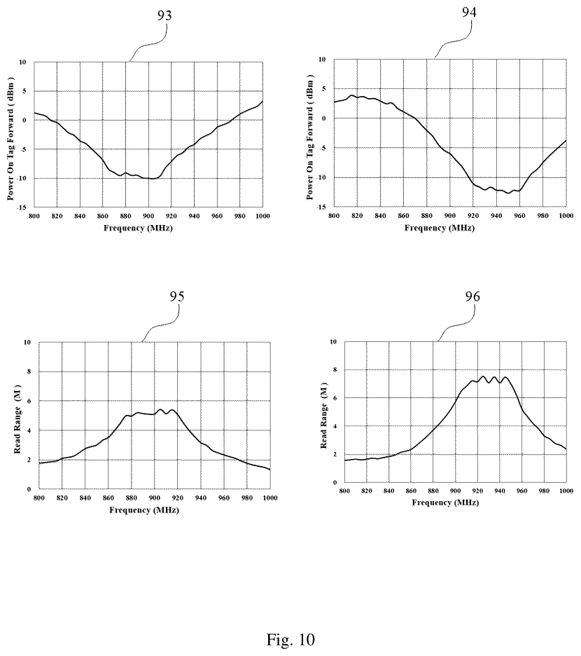

### DETAILED DESCRIPTION OF THE INVENTION

In this manual, the term ‘slit’ refers to a spatial area related to Radio-frequency Identification (RFID).

### Embodiment 1

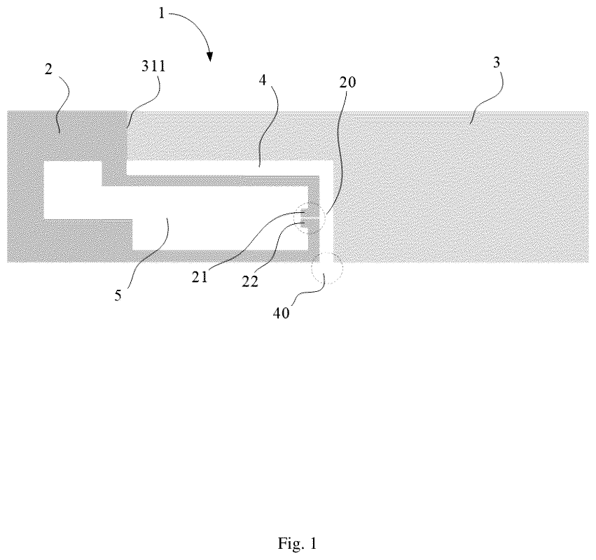

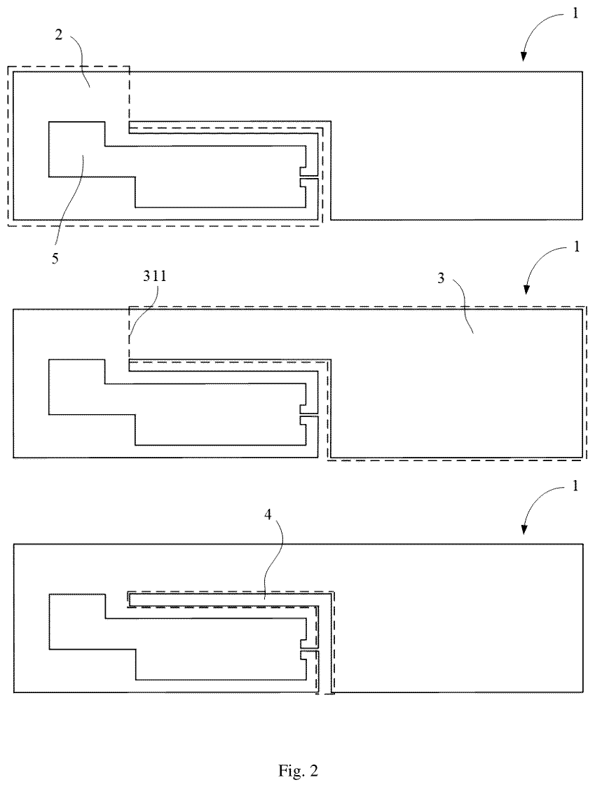

A label antenna structure suitable for the curved surfaces of liquid containers, as shown in FIGS. 1 and 2, includes: a deformed loop 2 surrounding a first slit 5, the deformed loop 2 comprising a loop gap 20, a first electrical connection terminal 21, and a second electrical connection terminal 22, with the first electrical connection terminal 21 and the second electrical connection terminal 22 spaced by the loop gap 20; a single-arm radiating plate 3, with an arm end 311 of the single-arm radiating plate 3 connected to the deformed loop 2; a second slit 4, which separates the unconnected portion between the deformed loop 2 and the single-arm radiating plate 3, with one end of the second slit 4 having an open circuit structure 40; an RFID chip (not shown in the figure) electrically connected between the first electrical connection terminal 21 and the second electrical connection terminal 22.

The deformed loop 2 is the impedance matching section of the label antenna structure suitable for the curved surfaces of liquid containers 1.

The material of the label antenna structure suitable for the curved surfaces of liquid containers 1 includes a flexible substrate, which can be a soft substrate such as PET or PI.

### Embodiment 2

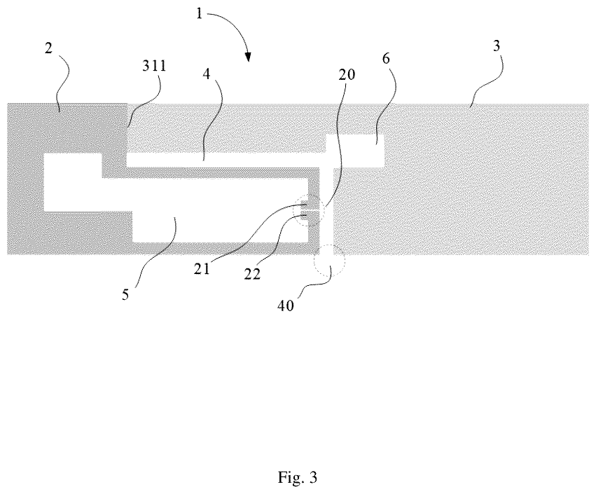

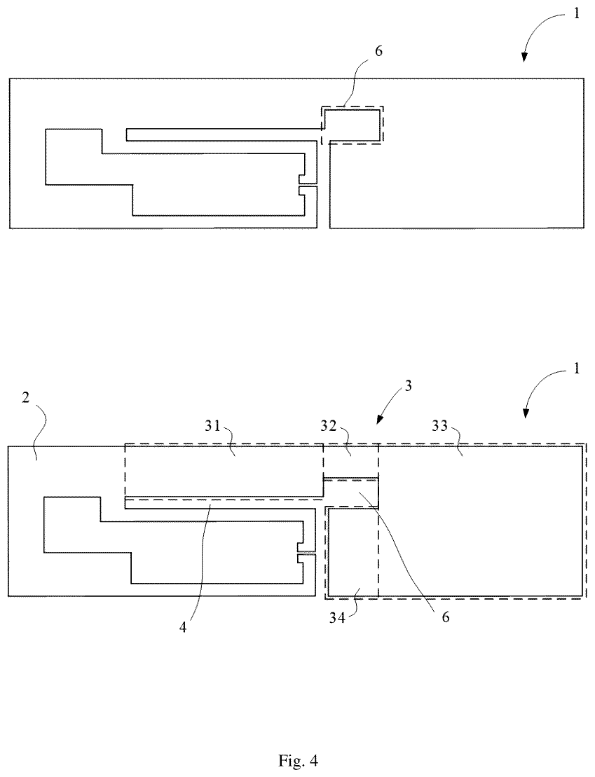

A label antenna structure suitable for the curved surfaces of liquid containers 1, as shown in FIGS. 3 and 4, includes: a deformed loop 2 surrounding a first slit 5, the deformed loop 2 comprising a loop gap 20, a first electrical connection terminal 21, and a second electrical connection terminal 22, with the first electrical connection terminal 21 and the second electrical connection terminal 22 spaced by the loop gap 20; a single-arm radiating plate 3, with an arm end 311 of the single-arm radiating plate 3 connected to the deformed loop 2; a second slit 4, which separates the unconnected portion between the deformed loop 2 and the single-arm radiating plate 3, with one end of the second slit 4 having an open circuit structure 40; an RFID chip (not shown in the figure) electrically connected between the first electrical connection terminal 21 and the second electrical connection terminal 22; and a third slit 6, which separates the single-arm radiating plate 3 and the second slit 4.

The shape of the third slit 6 is square-shaped.

As shown in FIG. 4, the single-arm radiating plate 3 is composed of multiple radiant panels, including a first radiant panel 31, a second radiant panel 32, a third radiant panel 33, and a fourth radiant panel 34.

The shape of the single-arm radiating plate 3 is composed of radiant panels of different sizes, all of which are square-shaped.

The larger the antenna area (A e) of the single-arm radiating plate 3, the higher the antenna gain (G=(4πAe)/λ²), which can improve the reading distance of the electronic tag.

The first radiant panel 31, the second radiant panel 32, the third radiant panel 33, the fourth radiant panel 34, and the second slit 4 surround the third slit 6.

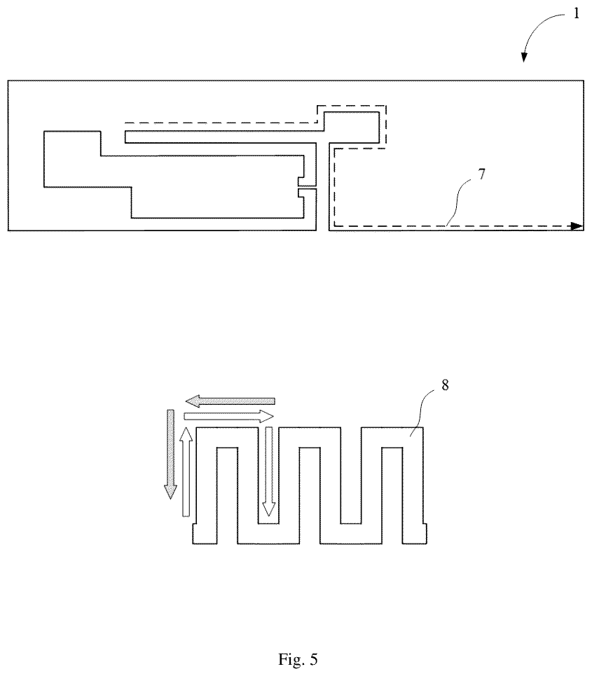

As shown in FIG. 5, the technology employed in the present invention connects the single-arm radiating plate 3, which has a quarter wavelength 7 (λ/4), through the deformed loop 2, without using a bent type winding 8 to reverse the phase of the induced current generated inside the liquid medium. This reduces the cancellation of the currents, allowing the antenna to radiate effectively.

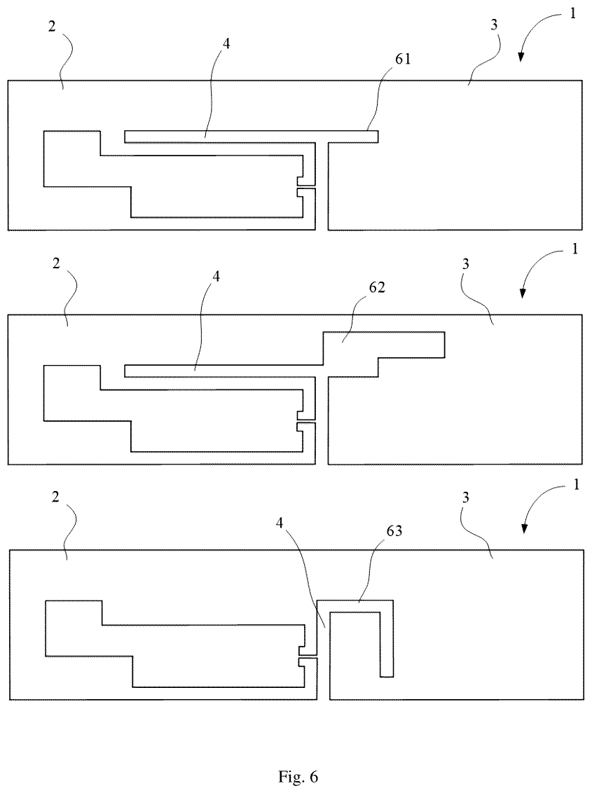

In an embodiment, as shown in FIG. 6, the third slit 6 is not limited to a specific shape. The second slit 4 connects to a rectangular slit 61, and the second slit 4 and the rectangular slit 61 form a T-shaped slit.

In an embodiment, the third slit 6 also includes a polygonal slit 62.

In an embodiment, the second slit 4 connects to an inverted L-shaped slit 63, forming an inverted U-shaped slit.

The dielectric constants of different types of glass bottles and containers vary, which can cause frequency shifts. Therefore, by adjusting the antenna impedance through different types of third slit 6, rectangular slit 61, polygonal slit 62, and inverted L-shaped slit 63, the slit shapes are tailored to match the chip impedance, forming impedance matching to accommodate the frequency and reading distance variations caused by different types of glass materials.

The RFID chip is an ultra-high frequency chip, and the RFID chip is connected between the first and second electrical connection terminals 21 and 22 via a conductive adhesive.

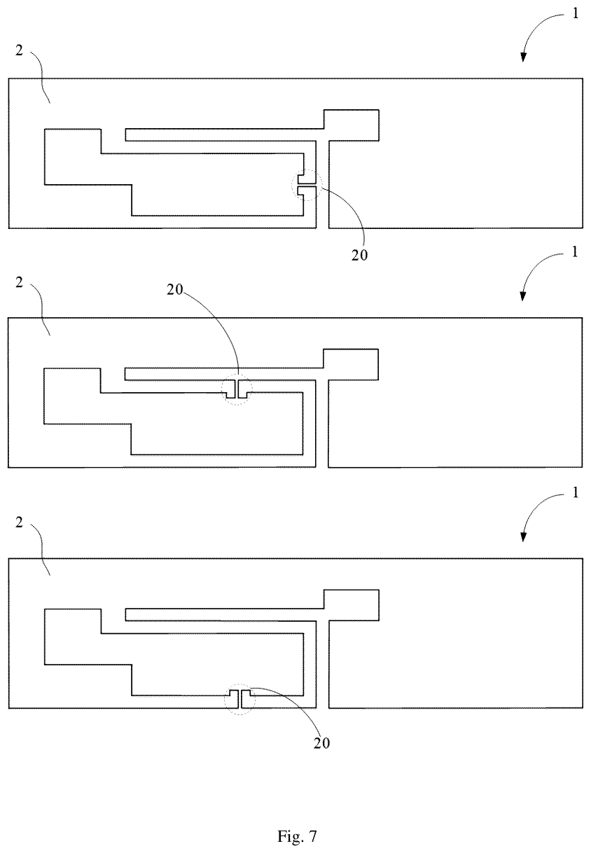

As shown in FIG. 7, the loop gap 20 can be positioned at any location on the deformed loop 2.

A label antenna structure suitable for the curved surfaces of liquid containers 1 also includes a substrate for supporting the antenna structure, with the substrate selected from PET substrate or other flexible substrates such as PI.

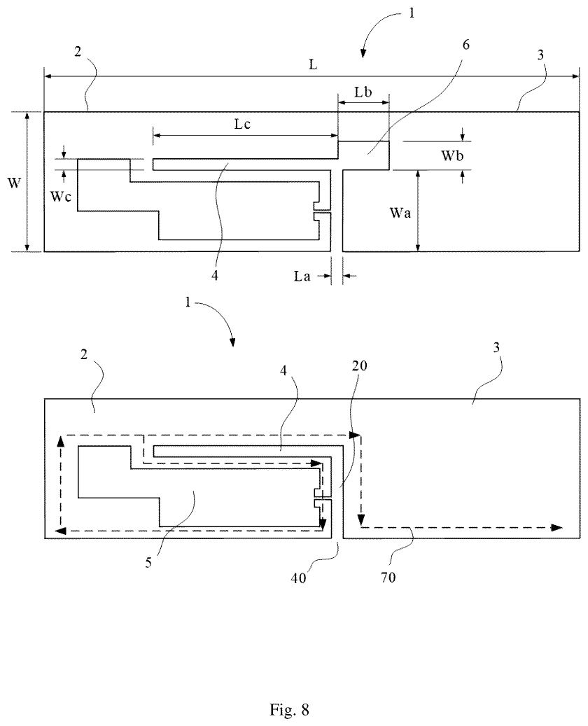

In an embodiment, as shown in the upper part of FIG. 8, the label antenna structure suitable for the curved surfaces of liquid containers 1 is rectangular, with a length (L) of 30~90 mm and a width (W) of 5~35 mm, with an optimal L*W of 48*12 mm.

In an embodiment, the second slit 4 includes a front section and a rear section. The length (Wa) of the front section is 0.5~25 mm, and its width (La) is 0.5~7 mm. The length (Lc) of the rear section is 5~30 mm, and its width (Wc) is 0.5~20 mm.

In an embodiment, the length (Lb1) of the third slit 6 is 0~30 mm, and its width (Wb) is 0~25 mm, with an optimal L*W of 48*12 mm.

In an embodiment, as shown in the lower part of FIG. 8, the deformed loop 2 and the first slit 5 form impedance matching. The current flows in an electric current direction 70, and the shape variation of the first slit 5 adjusts the inductive reactance of the antenna and the capacitive reactance of the chip.

The shape of the second slit 4 is L-shaped, and the open circuit structure 40 ensures that the electric current direction 70 of the deformed loop 2 is aligned with the current direction of the single-arm radiating plate 3, preventing current reversal that would counteract the energy.

1. A label antenna structure suitable for the curved surfaces of liquid containers, comprising:
a deformed loop surrounding a first slit, the deformed loop including a loop gap, a first electrical connection terminal, and a second electrical connection terminal, with the first electrical connection terminal and the second electrical connection terminal spaced apart by the loop gap;
a single-arm radiating plate, an arm end of which is connected to the deformed loop;
a second slit, with the portion of the deformed loop and the single-arm radiating plate that is not connected to each other being spaced by the second slit, the second slit having an open circuit structure at one end;
an RFID chip electrically connected to the first electrical connection terminal and the second electrical connection terminal;
the deformed loop and the first slit forming impedance matching, with current flowing through the first slit to adjust an inductive reactance of the label antenna structure suitable for the curved surfaces of liquid containers and a capacitive reactance of the RFID chip.

2. The label antenna structure suitable for the curved surfaces of liquid containers defined in claim 1, wherein the second slit includes an L-shaped slit or an inverted U-shaped slit.

3. A label antenna structure suitable for the curved surfaces of liquid containers, comprising:
a deformed loop surrounding a first slit, the deformed loop including a loop gap, a first electrical connection terminal, and a second electrical connection terminal, with the first electrical connection terminal and the second electrical connection terminal spaced apart by the loop gap;
a single-arm radiating plate, an arm end of which is connected to the deformed loop;
a second slit, with the portion of the deformed loop and the single-arm radiating plate that is not connected to each other being spaced by the second slit, the second slit having an open circuit structure at one end;
an RFID chip electrically connected to the first electrical connection terminal and the second electrical connection terminal;
a third slit, with the third slit spaced between the single-arm radiating plate and the second slit;
the deformed loop, the first slit, and the third slit form impedance matching, with current flowing through the first slit and the third slit to adjust an inductive reactance of the label antenna structure suitable for the curved surfaces of liquid containers and a capacitive reactance of the RFID chip.

4. The label antenna structure suitable for the curved surfaces of liquid containers defined in claim 3, wherein the single-arm radiating plate is composed of multiple radiant panels of different sizes.

5. The label antenna structure suitable for the curved surfaces of liquid containers defined in claim 3, wherein the radiant panels include a first radiant panel, a second radiant panel, a third radiant panel, and a fourth radiant panel.

6. The label antenna structure suitable for the curved surfaces of liquid containers defined in claim 3, wherein the second slit connects to a rectangular slit, and the second slit and the rectangular slit form a T-shaped slit.

7. The label antenna structure suitable for the curved surfaces of liquid containers defined in claim 3, wherein the third slit is a polygonal slit.

8. The label antenna structure suitable for the curved surfaces of liquid containers defined in claim 3, wherein the label antenna structure has a length of 30~90 mm and a width of 5~35 mm.

9. The label antenna structure suitable for the curved surfaces of liquid containers defined in claim 3, wherein the second slit includes a front section and a rear section, the dimensions of the front section being length 0.5~25 mm and width 0.5~7 mm, and the dimensions of the rear section being length 5~30 mm and width 0.5~20 mm.

10. The label antenna structure suitable for the curved surfaces of liquid containers defined in claim 3, wherein the dimensions of the third slit are length 0~30 mm and width 0~25 mm.
